(19) United States
(12) Patent Application Publication
(10) Pub. No.: US 2020/0253418 A1
(43) Pub. Date: Aug. 13, 2020

(54) GRILLING PLATE

(71) Applicant: SHELLY'S GRILLS, LLC, Sheboygan Falls, WI (US)

(72) Inventors: Shelly A. Stayer, Sheboygan Falls, WI (US); Ralph C. Stayer, Sheboygan Falls, WI (US); Scott Charles Larson, Sheboygan, WI (US)

(21) Appl. No.: 16/779,887

(22) Filed: Feb. 3, 2020

Related U.S. Application Data
(60) Provisional application No. 62/804,018, filed on Feb. 11, 2019.

(51) Int. Cl. A47J 37/06; A47J 36/02

(52) U.S. Cl. CPC A47J 37/067; A47J 36/02

(57) ABSTRACT

A grilling plate is configured for cooking sausage links or other meat products. The grilling plate includes a plate body and a first and second handle extending from opposite sides of the plate body. One or more link slots are formed in the plate body and the link slot(s) have a curved profile. Additionally, each of the link slot(s) have one or more corresponding drainage openings positioned therein that extend through the plate body.

### CROSS-REFERENCE TO RELATED APPLICATIONS

This application claims the benefit of U.S. Provisional Application No. 62/804,018 filed Feb. 11, 2019. The contents of that application are hereby incorporated by reference for all purposes as if set forth in their entirety herein.

### FIELD OF INVENTION

This disclosure relates to cooking food and, in particular, to grilling devices and accessories.

### BACKGROUND

Cooking outdoors is a popular activity that millions of people partake in each year. However, even seasoned cooks or grillers can struggle to properly cook meat products, particularly when cooking over an open flame. When the attention of a cook is divided while cooking multiple items on a grill, it can be difficult to achieve the desired taste for each item, to ensure that all items are evenly cooked, and to avoid burning any of the items.

### SUMMARY

When grilling meat products, retaining juices in the meat can ensure that the meat retains its flavor and does not become tough. If juices leak from the meat, they can also cause flare ups that can burn or char the meat unintentionally and further eliminate juices from the mean.

Disclosed herein is a grilling plate configured to be placed on a cooking surface, such as a grill surface, in order to cook multiple sausage links. The grilling plate can include a plurality of link receiving slots that help to seal in the juices of the links and control their exposure to the flames of the grill, thereby reducing the probability of flare ups. The link slots may have a curved shape that corresponds to the curved shape found in sausage links and this can, among other things, help evenly distribute the heat over the surface of the sausage links.

According to one aspect, a grilling plate for cooking sausage links includes a plate body and one or more handles that extend from the plate body. One or more link slots are formed in the plate body and the link slot(s) have a curved profile that can corresponding to the shape of the meat product being cooked. One or more drainage openings are positioned in each one of the link slots. The drainage openings extend through the plate body so that any juices from the link(s) being grilled may be controllably drained during the grilling process while simultaneously preventing the possibility of flare ups or of the meat products drying out during the cooking process.

In some forms, the one or more link slots may include a plurality of link slots. The plurality of link slots may be nested in one another such that a convex upper edge of one the link slots is received in a concave upper edge of an adjacent one of the link slots. This can among other things, maximize the space in the grilling plate for cooking sausage links.

In some forms, each of the various link slot(s) with one or more drainage opening(s) may have a plurality of drainage openings.

In some forms, the grilling plate may have a raised rim formed proximate the outer periphery of a top surface of the plate body.

In some forms, the drainage openings may extend through the plate from an upwardly-facing surface of the at least one link slot to a downwardly-facing surface of the plate.

In some forms, the grilling plate may be metal, such as aluminum or cast iron, for example. However, other materials might be used, considering that materials that heat evenly will be well suited for this application. Further, a coating may be applied in some circumstance to improve cleanability; for example, a porcelain coating could be applied to an aluminum plate to provide temperature resistances of 900 degrees Fahrenheit as well as to permit the plate to be cleaned in a dishwasher. Of course other types of ceramic coatings might be place on other types of metal substrates to similar effect.

In some forms, the link slot(s) may be curved on a plane of the plate body and may further have a cross-sectional profile perpendicular to the plane in which the cross-sectional profile is concave over at least a portion of the depth of the link slot(s). The drain opening(s) may be at a local minimum of the cross-sectional profile that is concave.

In some forms, one or both of the first handle and the second handle may include an upwardly-facing display area thereon for reception of a branding indicia. Such indicia may be embossed on the surface for instance or provided such that the branding is provided by surface relief on an otherwise smooth surface of the handle(s).

These and still other advantages of the invention will be apparent from the detailed description and drawings. What follows is merely a description of some preferred embodiments of the present invention. To assess the full scope of the invention the claims should be looked to as these preferred embodiments are not intended to be the only embodiments within the scope of the claims.

### DESCRIPTION OF THE DRAWINGS

FIG. 1 is a grilling plate including a plurality of link slots formed into a plate body;

FIG. 2 is a top-down plan view of the grilling plate of FIG. 1;

FIG. 3 is a front elevation view of the grilling plate of FIG. 1; and

FIG. 4 is a side elevation view of the grilling plate of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As used herein, unless otherwise specified or limited, the term “sausage link” refers generically to any meat product enclosed in a casing or competitive product therewith. For example, “sausage link” can refer to a hot dog, bratwurst, kielbasa, chorizo, andouille, salami, or any other type of sausage or cased meat product. It is contemplated that many such sausage links and cased meat products curve over the length of the product.

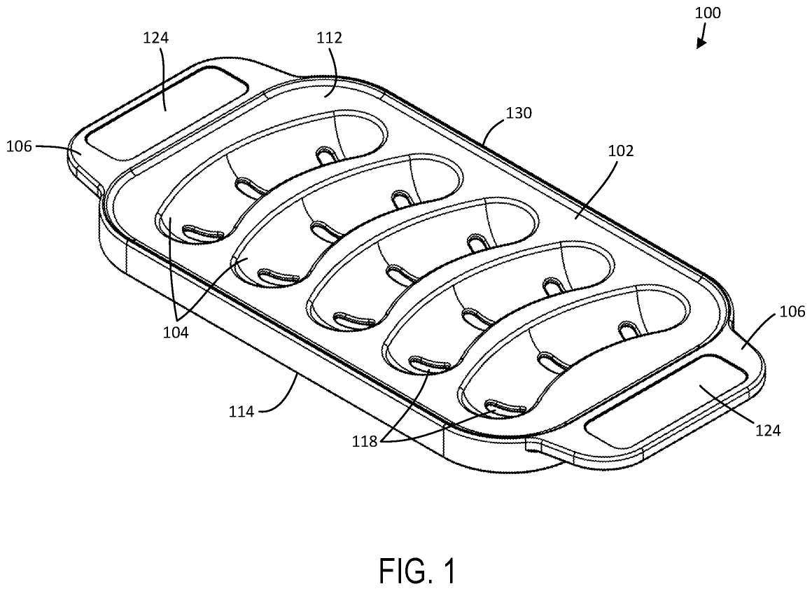

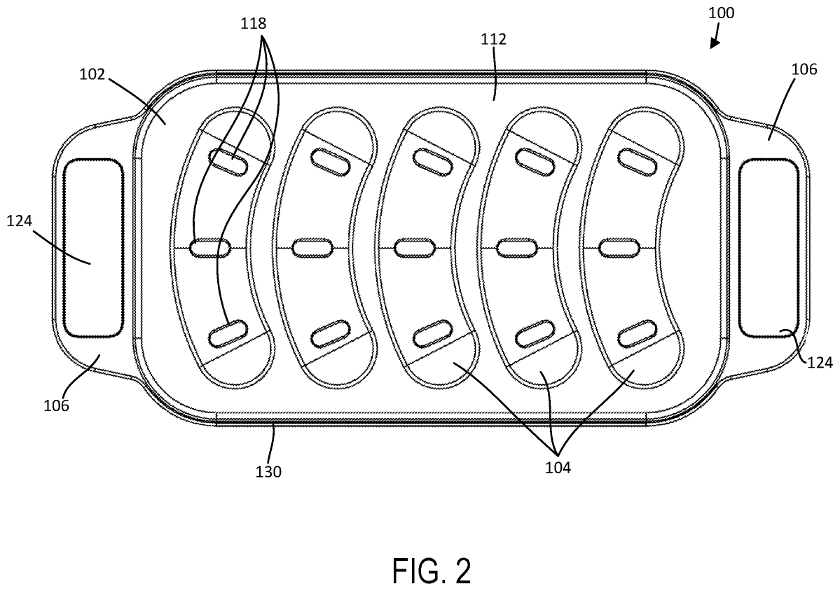

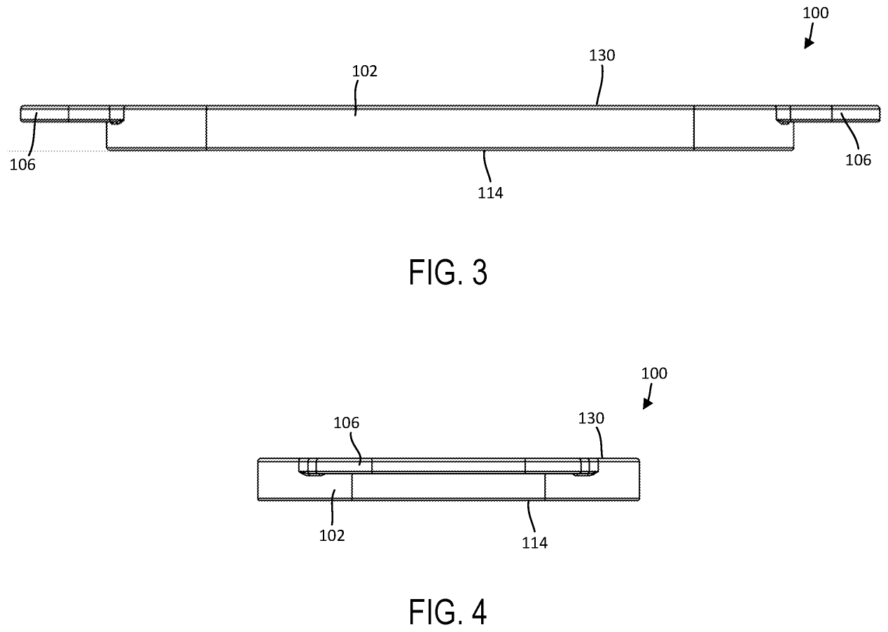

Referring now to FIGS. 1 through 4, a grilling plate 100 for cooking sausage links is illustrated. The grilling plate 100 includes a plate body 102, which is generally planar, and includes a plurality of link slots 104 formed on a top surface thereof in which each slot 104 is configured to receive a corresponding sausage link (not shown). The plate body 102 also has two handles 106 on opposing lateral sides thereof for holding the grilling plate 100. As will be discussed in greater detail below, it is contemplated that this entire grilling plate 100 can be unitarily formed from aluminum or cast iron, for example, which distributes heats evenly throughout and retains heat over a period of time. Still further, the metal can be coated with a ceramic such as porcelain. In use and generally speaking, the grilling plate 100 can be placed over or directly on a grill (not shown) or on any other grilling, cooking or heating surface, in order to cook the sausage links received therein. Once the plate 100 is heated, the sausage links can be placed in the link slots 104 and, as needed, the sausage links can be flipped or rotated in the link slots 104. Once cooked, the sausage links can be removed from the link slots 104 before or after the grilling plate 100 is removed from the grill.

In the illustrated embodiment, the plate body 102 has a generally rectangular shape with a substantially flat top surface 112. The bottom surface 114 of the plate body 102 may also be substantially flat, which may be useful to provide a stable, level surface for putting a grilling plate on a grill or other cooking surface. Some embodiments of a grilling plate may have a plate body with a shape and/or size that is different than the shape and size illustrated.

In some embodiments, the plate body can be composed of metal such as aluminum or cast iron and may be formed through a metal casting process, or by any other metal forming method. In some embodiments, the grilling plate can be composed of another material. Further, a coating may be applied in some circumstance to improve cleanability. For example, a porcelain coating could be applied to an aluminum plate to provide temperature resistances of 900 degrees Fahrenheit as well as to permit the plate to be cleaned in a dishwasher.

In the form illustrated, the plurality of link slots 104 are arranged generally parallel with one another in a linear pattern in the plate body 102 and formed on the top surface 112 of the plate 100. Each of the link slots 104 are arcuately curved to generally correspond to the curved profile of the links that will likely be received therein. In the illustrated embodiment, the link slots 104 are positioned so that a portion of some of the slots extends into the circular segment defined by the arc of the adjacent slot (i.e., a convex upper edge of some of the slots “nest” into a concave upper edge of one another of the slots). This may be useful, for example, in order to include a larger number of link slots in a compact plate body. In the illustrated embodiment, the grilling plate 100 includes five link slots 104; however, other configurations are possible. For example, a grilling plate can include more than five link slot or fewer than five link slots. In some non-limiting examples, the link slots can be arranged in a pattern that is the same or different than that of the illustrated grilling plate. For example, the links slots can be arranged in and number of rows or columns or they can be arrange in a non-linear pattern or even positioned arbitrarily or fancifully (e.g., in a spiraling or generally radially outwardly oriented pattern).

With continued reference to FIGS. 1-4, the bottom surface of each link slot 104 curves downward and away from top surface 112 to define a mostly uniform, concave semi-circular cross-section of the link slots 104. As such, the sides of the link slots 104 generally conform to and may make substantially continuous contact with a sausage link received therein. The depth of the link slots 104 can be selected so that, while received in a link slot 104, approximately half of the sausage link is below the top surface 112 of the plate body 102 while the other half of the sausage link extends above the top surface 112.

A plurality of drainage openings 118 are positioned in each link slot 104 at their bottoms and extend through the plate body 102 from the bottom of the upwardly-facing surface of the slots 104 to a bottom surface 114 of the plate body 102. The drainage openings 118 are spaced apart along the length of the link slots 104 and are elongated in a direction perpendicular to the arc of the link slots 14. This may be useful, for example, to allow fluids to drain out of the link slots 104 or to provide a pathway for direction heat convection through the plate that does not transmit through the material of the plate 100 itself.

While each of the illustrated link slots 104 includes three evenly space drainage openings 118, some embodiments of a may have more than three or fewer than three drainage openings. Indeed, in some designs, some or all of the link slots may no drainage openings at all. Further, some embodiments can include at least one drainage opening that have a different size and/or are in a different orientation than the illustrated drainage openings

A grilling plate can also include additional features. As illustrated in FIGS. 1-4, for example, the grilling plate 100 includes two handles that extend horizontally from opposite sides of the plate body 102. The handles 106 are generally flat and are configured to provide a structure that can be griped by a user even while using bulky or unwieldy protective equipment. Notably, the handles 106 can also provide a display area 124 that may be used to display labels, instructions, a company name, branding, or a logo, or any other desirable information or promotional labeling. Still further, the illustrated grilling plate 100 also includes a raised rim 130 formed around the edge of the top surface 112 of the plate body 102. The raised rim 130 may be useful, for example, in order to prevent fluids from spilling over the sides of the plate body 102 or onto the handles 106. In some embodiments, at least one of the handles or the raised rim may have a different shape or size than the illustrated embodiment. Further, a grilling plate can include additional handles or rims, or at least one of the handles or the raised rim may be omitted.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto.

What is claimed is:

1. A grilling plate configured to cooking sausage links, the grilling plate comprising:
a plate body;
a first handle and a second handle extending from opposite sides of the plate body;
at least one link slot formed in the plate body, the at least one link slot having a curved profile; and
at least one drainage opening positioned in each one of the at least one link slot, the at least one drainage opening extending through the plate body.

2. The grilling plate of claim 1, wherein the at least one link slot includes a plurality of link slots.

3. The grilling plate of claim 3, wherein the plurality of link slots are nested in one another such that a convex upper edge of one the link slots is received in a concave upper edge of an adjacent one of the link slots.

4. The grilling plate of claim 1, wherein the at least one drainage opening includes a plurality of drainage openings.

5. The grilling plate of claim 1, further comprising a raised rim formed proximate an outer periphery of a top surface of the plate body.

6. The grilling plate of claim 1, wherein the at least one drainage opening extends through the plate from an upwardly-facing surface of the at least one link slot to a downwardly-facing surface of the plate.

7. The grilling plate of claim 1, wherein the grilling plate is composed of metal.

8. The grilling plate of claim 7, wherein the grilling plate is comprises of aluminum.

9. The grilling plate of claim 7, wherein the grilling plate is comprises cast iron.

10. The grilling plate of claim 7, wherein the grilling plate includes a ceramic coating.

11. The grilling plate of claim 1, wherein the at least one link slot is curved on a plane of the plate body and further has a cross-sectional profile perpendicular to the plane in which the cross-sectional profile is concave over at least a portion of the depth of the at least one link slot.

12. The grilling plate of claim 11, wherein the at least one drain opening is at a local minimum of the cross-sectional profile that is concave.

13. The grilling plate of claim 1, wherein at least one of the first handle and the second handle includes an upwardly-facing display area thereon for reception of a branding indicia.
